(19) United States
(12) Patent Application Publication
(10) Pub. No.: US 2022/0183482 A1
(43) Pub. Date: Jun. 16, 2022

(54) INSECT PROTECTION DEVICE AND GAZEBO STRUCTURE WITH A FRAME WHICH HAS A ROTARY JOINT

(71) Applicant: Arnd Büdenbender, Netphen-Deuz (DE)

(72) Inventors: Arnd BÜDENBENDER, Netphen-Deuz (DE); Ritske Johannes VAN LEEUWEN, Koedijk (NL)

(21) Appl. No.: 17/601,362

(22) PCT Filed: Apr. 15, 2020
(86) PCT No.: PCT/EP2020/060559

§ 371 Date: Oct. 4, 2021

(30) Foreign Application Priority Data
Apr. 25, 2019 (EP) 19171031.8

(51) Int. Cl. A47G 1/06; A47G 1/10

(52) U.S. Cl. CPC A47G 1/0605; A47G 2001/0661; A47G 1/101

(57) ABSTRACT

The present invention relates to a frame comprising at least two first frame struts (1.1, 1.2) and at least two second frame struts (2.1, 2.2), wherein⋅the two first frame struts (1.1, 1.2) and/or the two second frame struts (2.1, 2.2) are of invariable length, ⋅the first frame struts (1.1, 1.2) are connected at their ends in each case to a second frame strut (2.1, 2.2) and the second frame struts (2.1, 2.2) are connected at their ends in each case to a first frame strut (1.1, 1.2), and —the first frame struts (1.1, 1.2) and the second frame struts (2.1, 2.2) are arranged at a right angle with respect to one another in a frame plane in an assembled position.

The present invention relates to an insect protection device and a pavilion structure, in each case comprising a frame, comprising at least two first, in particular one-piece, frame struts and at least two second, in particular one-piece, frame struts, wherein the two first and/or the two second frame struts are of invariable length, the first frame struts are connected at their ends in each case to a second frame strut and the second frame struts are connected at their ends in each case to a first frame strut and the first frame struts and the second frame struts are arranged at a right angle with respect to one another in a frame plane in an assembled position.

A frame in which both the two first frame struts and the two second frame struts are of invariable length might be implemented, for example, by a conventional picture frame in which the frame struts are fixedly connected together. In the case of large pictures, however, such a picture frame spans a very large surface area. It might be conceivable, therefore, to provide the frame struts of the picture frame as a construction kit to the end user so that the end user would have to connect together the frame struts at the ends thereof. This is associated, however, with a certain degree of effort for the end user.

For example, a pavilion structure also has such a (partial) frame arranged at right angles in the assembled position. In this case, the end user has to connect together the frame struts consisting, for example, of a plurality of tubes, respectively via corner connectors, before the entire pavilion is able to be constructed. A pavilion structure is disclosed, for example, in U.S. Pat. No. 6,283,136 B1.

Construction kits in which the end user has to connect together the frame struts via corner connectors during assembly are also known in the field of insect protection devices. An insect protection device is disclosed, for example, in EP 3 138 990 A1.

It is the object of the present invention, therefore, to remedy the drawbacks set forth relative to the prior art and, in particular, to specify an insect protection device and a pavilion structure which is more user-friendly and may be assembled with less effort.

The object is achieved by an insect protection device and a pavilion structure having the features of the respective independent claim. Advantageous developments of the frame are specified in the dependent claims and in the description, wherein individual features of the advantageous developments may be combined together in a technically expedient manner.

The object is achieved, in particular, by an insect protection device and a pavilion structure with a frame, having the features set forth in the introduction, in which the connections in each case between a first frame strut and a second frame strut in each case have a rotary joint having at least one axis of rotation, wherein the rotary joints are configured such that in an initial position both the two first frame struts and the two second frame struts are (all) oriented parallel to one another and the frame is transferrable into the assembled position by pivoting the frame struts relative to one another about the axes of rotation of the rotary joints.

The basis idea of the invention thus provides that the frame struts are connected together in the manner of hinges so that the frame struts which are preassembled via the rotary joints may be provided to the end user in a compact initial position in which the frame struts, which are arranged at right angles in the assembled position, are initially arranged parallel to one another. The end user then merely has to fold the frame out of its initial position into the assembled position.

The invention relates to such frames in which the height and/or the width of the frame is fixedly predetermined for the end user. In particular, the invention relates to such frames in which both the two first frame struts and the two second frame struts are of invariable length. Alternatively, the invention relates to such frames in which either the length of the first frame strut or the length of the second frame strut is invariable, whilst the length of the respective other two frame struts is variable.

A frame strut which is of invariable length may be configured, for example, in one piece, wherein the end user is naturally at liberty to shorten the one-piece frame strut. The frame strut may be formed, for example, by an inner hollow profile strip, a tube or a solid profile with any cross section. A frame strut which is of invariable length, however, may also be configured in multiple parts if the plurality of parts may be connected together only such that the frame strut has a predetermined length. For example, the plurality of parts of the frame strut may be connectable together via suitable plug-in latching connections. If, for forming a rectangular frame, the first frame struts have an equal length and the second frame struts have an equal length, which differs from the length of the first frame struts, in particular it may be provided that in order to form a square frame all of the frame struts have an equal length.

A frame strut which is of variable length is configured in multiple parts and comprises, in particular, at least one outer profile strip and at least one inner profile strip which is inserted in a telescopable manner to a variable insertion depth into the outer profile strip(s). The two first frame struts or the two second frame struts thus comprise in each case at least one outer profile strip and at least one inner profile strip. In the assembled position, the end user may change the height or the width of the frame in a simple manner by telescoping the inner profile strips and outer profile strips relative to one another.

The (multipart) frame struts have the rotary joints at their ends so that the loaded rotary joints are exclusively arranged between a first frame strut and a second frame strut. However, no rotary joint is intended to be configured between the parts of a multipart frame strut.

Thus the end user is then able to fix the frame, which is altered in terms of height or width, to the corresponding insertion depth between the inner profile strip and the outer profile strip by suitable means. The means for fixing the insertion depth may comprise at least one of the following elements:
a screw by which an inner profile strip and an outer profile strip are fixed together,
an adhesive strip, preferably also double-sided, extending over the entire length of a frame strut, wherein preferably in the case of a single-sided adhesive strip a plurality of (more than 10 or more than 100) T-shaped latching hooks are configured on the upper face thereof remote from the adhesive side, for securing an insect protection net,
an adapter profile strip which may be attached to the inner profile strip and which is fitted onto a projection extending along the inner profile strip or, respectively, inserted into a groove extending along the inner profile strip, wherein an outer profile or, respectively, an inner profile of the adapter profile strip is aligned with a corresponding profile of a projection or, respectively, a groove of the outer profile strip, wherein preferably a clamping strip extending over the entire frame strut may be fitted onto the adapter profile strip (in the region of the inner profile strip) and onto the projection (in the region of the outer profile strip).

The frame according to the invention consisting of a total of four frame struts may also be simply part of a frame or structure comprising further frame struts. It is only required that the two first frame struts according to the invention, which are also arranged parallel to one another in the assembled position, and the two second frame struts, which also are arranged parallel to one another in the assembled position, form in the assembled position a right-angled (partial) frame.

It is provided, in particular, that a latching element is configured at the end of the first frame strut and a latching element which is complementary to the first latching element is configured at the end of the second frame strut so that the frame struts are latched together in the assembled position. The latching element, for example, may have, in particular, a hook-shaped projection which engages behind a corresponding complementary undercut on the second frame strut in the assembled position. In this manner, a first securing may be provided, the frame struts being secured thereby in the assembled position against being inadvertently pivoted back.

So that the frame struts provide the frame with a high degree of stability in the assembled position, it may be provided that the first frame strut has a stabilising element which projects in the initial position in the direction of the second frame strut and which in the assembled position overlaps the second frame strut. The stabilising element which projects, in particular, in one piece on the frame strut is received, in particular, in a corresponding recess of the second frame strut. In this case, it may be provided, in particular, that at least one latching element is configured on the stabilising element.

The rotary joint between two frame struts has, in particular, just two axes of rotation, the one axis of rotation thereof being able to be configured in or on the first frame strut and the second axis of rotation thereof being able to be configured in or on the second frame strut. The axes of rotation of each rotary joint which are oriented, in particular, parallel to one another, in this case are connected together via at least one connecting element.

In one embodiment, the axes of rotation of the rotary joints of the corners of the frame diagonally opposing one another in the assembled position are oriented at right angles to the frame plane. Such a rectangular frame (portion) thus has four frame struts, wherein the diagonally opposing profile connectors, i.e. which are not connected to the same frame strut, have an axis of rotation oriented at right angles to the frame plane spanned by the frame struts in the assembled position.

In this connection, it is provided that the other two corners of the frame, which in each case also diagonally oppose one another in the assembled position, have axes of rotation which in the assembled position are oriented parallel to the frame plane or are arranged in the frame plane. The axes of rotation of these rotary joints are in this case oriented, in particular, at an angle of 45 degrees to the direction of extension of the frame struts.

With such an arrangement it is possible that in each case two pairs of frame struts, which are arranged parallel to one another in the initial position, are initially transferrable by pivoting about the axes of rotation oriented at right angles to the frame plane into an intermediate position, in which the two pairs of parallel frame struts are arranged at a right angle to one another, wherein the frame struts are subsequently transferrable from the intermediate position into the assembled position by pivoting two pairs of frame struts, which are arranged at right angles to one another in the intermediate position, about the axes of rotation arranged parallel to or in the frame plane.

In other words, therefore, the frame struts which are arranged parallel to one another in the initial position are firstly moved by a pivoting movement into a right-angled arrangement relative to one another, by the frame struts being pivoted about the axes of rotation arranged at right angles to the frame plane. Subsequently, the frame is then unfolded further by the frame struts being pivoted about the axes of rotation arranged in the frame plane, wherein the corners already arranged at right angles to one another (and having the axes of rotation oriented at right angles to the frame plane), which were still arranged adjacent to one another in the intermediate position, are moved onto the diagonally opposing sides of the unfolded frame. One of the corners, which is already arranged in the intermediate position between two frame struts oriented at right angles to one another, thus describes a type of circular arc movement from the intermediate position into the assembled position.

In an alternative embodiment of the frame, the axes of rotation of all of the rotary joints are oriented at right angles to the frame plane. In this case, in particular, the axes of rotation of diagonally opposing rotary joints are arranged on the outside of the frame, whilst the axes of rotation of the further diagonally opposing rotary joints are arranged toward the inside of the frame. In this manner, during the folding process the frame struts of the frame are arranged in a rhombus-shape relative to one another (the first frame struts are arranged parallel to one another and the second frame struts are arranged parallel to one another) such that the frame struts in the initial position are oriented parallel to one another.

It may also be provided that a separate fixing element is provided for each rotary joint, said fixing element being able to be connected to two adjacent frame struts in the region of the rotary joint in the assembled position and thus securing the adjacent frame struts against being pivoted. For example, such a fixing element may be configured as a cover cap which may be secured in adjacent frame struts. The cover caps are thus configured, in particular, two-dimensionally and connected to both frame struts. To this end, the cover caps may be secured positively to the frame struts, for example, by means of a latching connection. The cover cap may also be fastenable in a non-positive manner to the profile connector. Alternatively, it may be provided that in each case a receiving channel is configured in adjacent frame struts, wherein the receiving channels of adjacent frame struts are arranged aligned with one another in the assembled position, wherein a fixing element may be introduced into the receiving channels arranged aligned with one another by a linear movement.

Insofar as according to the above description the elements for forming the rotary joint and for stabilizing/latching the adjacent frame struts are configured, in particular, in one piece or directly on the frame struts, for simplifying the production it may also be provided that the frame struts in each case have a profile strip (configured to be hollow or solid) and profile connectors which in each case have at least one first connecting arm and one second connecting arm, wherein the first connecting arm is connected by means of a plug-in connection to a first profile strip of the first frame strut and the second connecting arm is connected by means of a plug-in connection to a second profile strip of the second frame strut, wherein the rotary joint is configured between the first connecting arm and the second connecting arm.

The connecting arms of the profile connectors have in each case, in particular, an insertion portion which is located in the profile strip and which is secured non-positively and/or positively in the profile strip. Additionally each connecting arm, in particular, has a corner portion which projects over the profile strip and thus is arranged outside the profile strip and is configured, in particular, in one piece with the insertion portion on or in which the at least one axis of rotation of the rotary joint is configured. Each profile connector is thus configured in multiple parts and comprises at least the first connecting arm, the second connecting arm and optionally elements configured as separate components for forming the axis of rotation. It is also possible that the frame struts are inserted into connecting arms of the profile connectors.

Thus the elements for forming the rotary joint may also be configured, however, on one and/or both connecting arms of the profile connectors.

This also permits a modular design by which the profile connectors may be produced independently of the frame struts.

Such profile connectors form, in particular, the corners of the frame in the assembled position so that the axes of rotation of the rotary joints of opposing profile connectors are oriented at right angles to the frame plane in the assembled position, wherein the other two profile connectors, also in each case diagonally opposing one another, have axes of rotation which in the assembled position are oriented parallel to the frame plane or arranged in the frame plane.

However, the latching elements and the complementary latching elements and/or the stabilising elements and complementary stabilising elements may also be configured on the connecting arms of the profile connector. Additionally the elements for fixing the frame in its assembled position (fixing elements) may also be configured for attaching to the profile connectors.

In this connection, in particular, the first connecting arm has a first receiving channel and the second connecting arm has a second receiving channel, wherein in the assembled position the first receiving channel and the second receiving channel are arranged aligned with one another, wherein a separate fixing element, which in the assembled position is able to be introduced into the first receiving channel and into the second receiving channel by a linear movement, is provided so that the first connecting arm and the second connecting arm are secured against a relative movement. The fixing element may be configured, in particular, as a suspension element by which the frame forming a part of an insect protection device may be attached to a frame of a window.

In one embodiment, the frame is provided for use as an insect protection device for a window, in which case the frame consists, in particular, of two lateral vertical frame struts and a lower and an upper horizontal frame strut, wherein the profile connectors are configured as corner connectors with in each case just two connecting arms which are pivotable relative to one another. Such a frame may be fastened to a window frame by means of the suspension elements already described above.

The proposed frame may also be provided, however, for an insect protection device assigned to a door opening, in which case the frame is able to be fastened, for example, by means of hinges to a door frame. In this case, the frame consists, in particular, of four lateral frame struts and of a lower, a central and an upper horizontal frame strut, wherein the central frame strut is connected in each case at both ends by means of a profile connector, configured as a central connector, to two vertical frame struts, wherein the central connector in each case has three connecting arms.

The frame may be used for spanning a two-dimensional insect protection net. The frame may also be used as a frame for a pleated insect protection net. To this end, for receiving a pleated fabric at least the vertical frame struts have a continuous opening along their direction of extent which faces a frame interior. Thus an edge of the pleated fabric may be arranged inside the vertical frame struts, wherein the pleated fabric extends as far as the opposing vertical frame strut and into said frame strut.

The insect protection device thus comprises a frame and an insect protection net which is movably fastened on or in the frame in the case of a pleated fabric.

The frame according to the invention, however, may also be part of a pavilion structure in which the frame forms a part of the pavilion structure configured as a rectangle. In particular, the frame according to the invention forms the part of the frame oriented horizontally in the assembly state, to which the feet of the pavilion structure adjoin at the bottom, wherein a structure for forming a roof structure is arranged above the partial frame. In this case, third frame struts for forming a roof structure and fourth frame struts for forming feet may be attached in an articulated manner at the ends of the first and second frame strut, so that in the initial state these frame struts may also be arranged parallel to the other frame struts. In this connection, in particular, it is preferred if corresponding further connecting arms which are connected to the third and/or fourth frame struts are configured on the profile connectors. Thus the third and fourth connecting arms of the profile connector might then be configured in an articulated manner on the first and second connecting arms. The third and/or fourth frame struts in this case are preferably connected in an articulated manner to the first and second frame struts such that in the initial position the third and/or fourth frame struts may also be arranged parallel to the first and second frame struts.

The invention and the technical background are described by way of example hereinafter by means of the figures, in which schematically

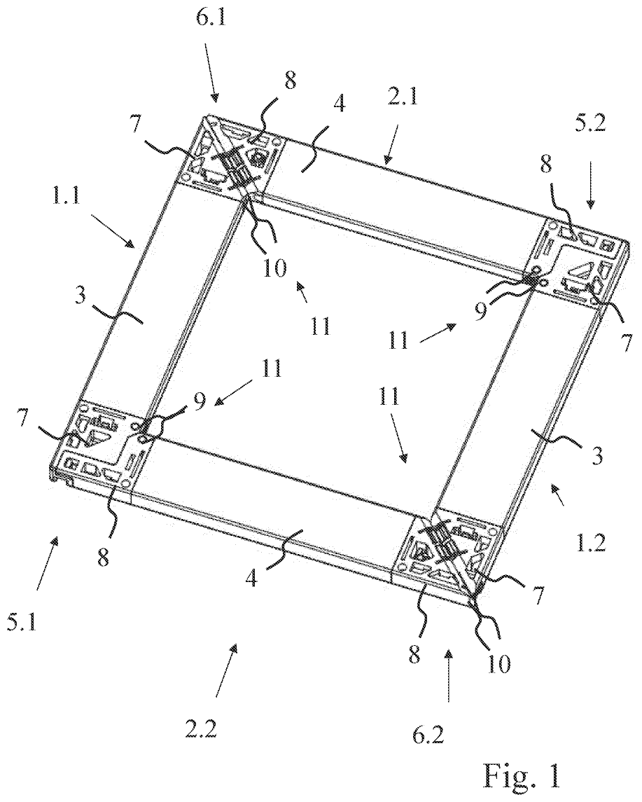

FIG. 1: shows a frame in the assembled position,

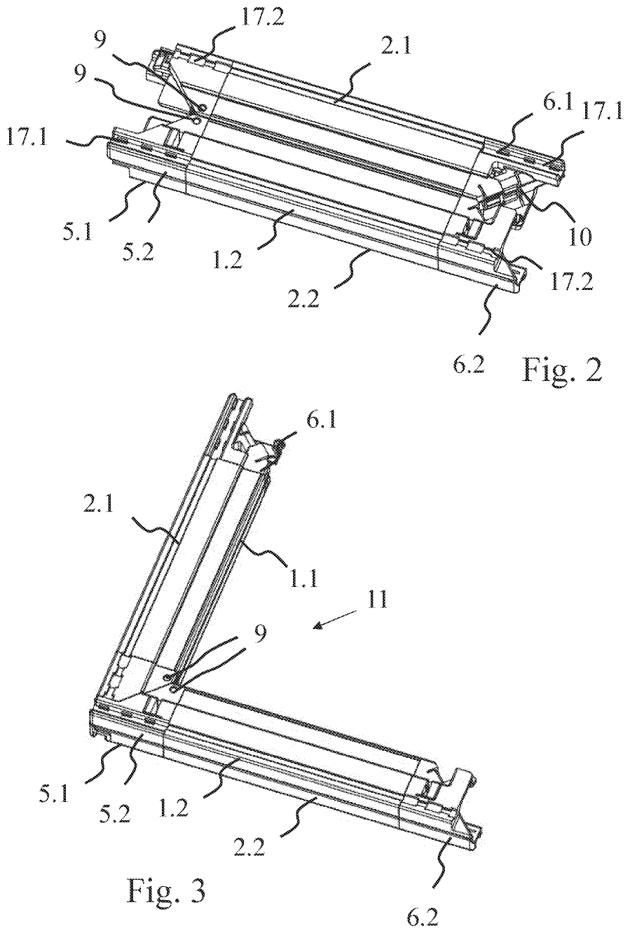

FIG. 2: shows the frame in an initial position,

FIG. 3: shows the frame in an intermediate position,

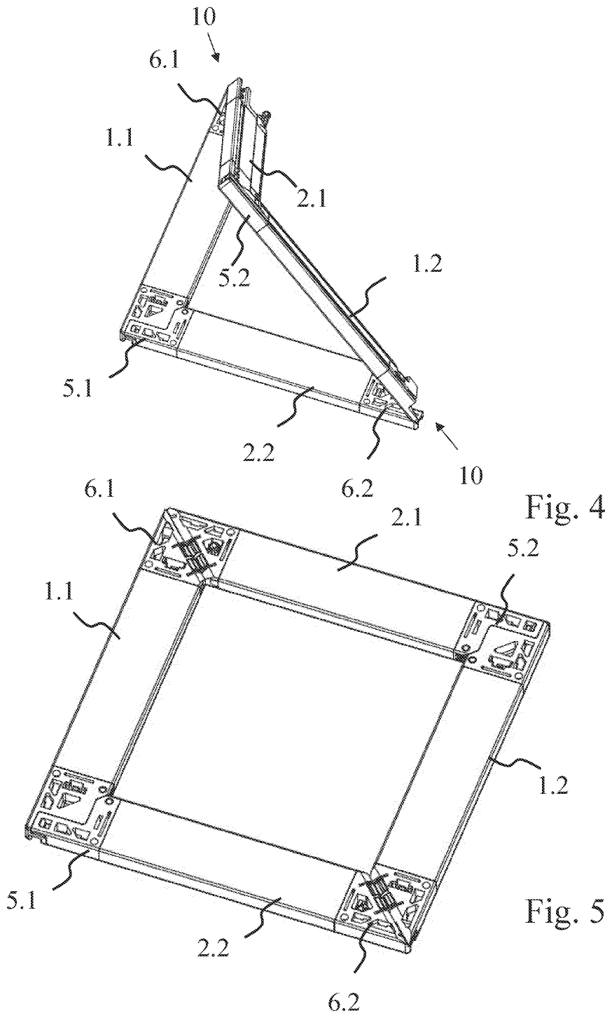

FIG. 4: shows the frame when transferred from the intermediate positon into an assembled position;

FIG. 5: shows the frame in the assembled position,

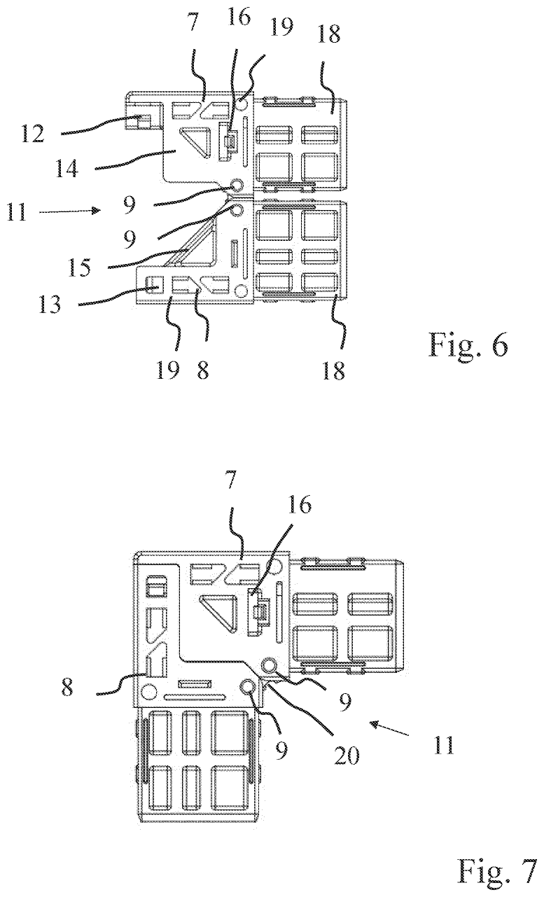

FIG. 6: shows a profile connector with axes of rotation in the initial position oriented at right angles to the frame plane,

FIG. 7: shows the profile connector according to FIG. 6 in the assembled position,

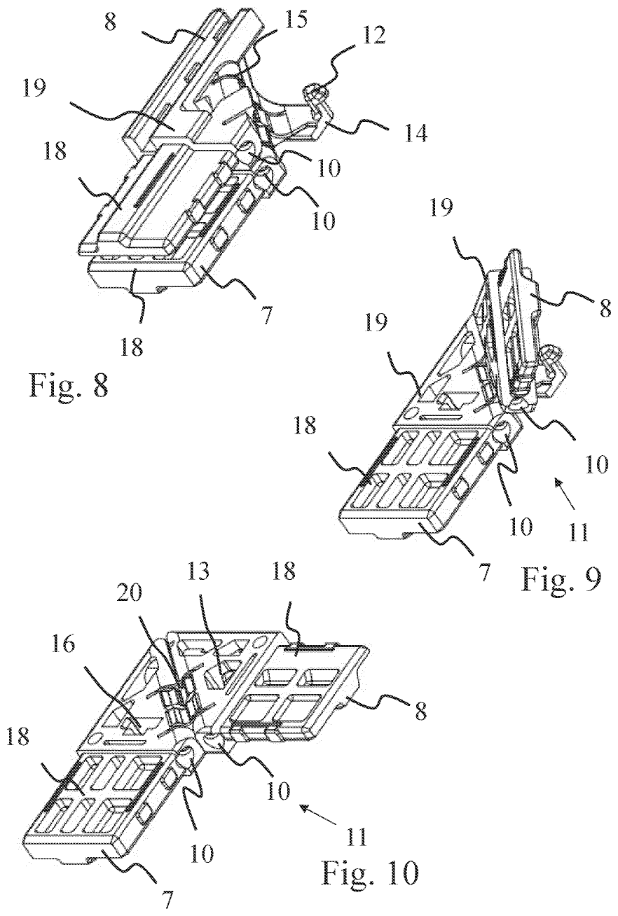

FIG. 8: shows a profile connector with axes of rotation in the initial position oriented parallel to the frame plane,

FIG. 9: shows the profile connector according to FIG. 8 when transferred from the intermediate position into the assembled position and

FIG. 10: shows the profile connector according to FIG. 8 in the assembled position.

The frame shown in FIGS. 1 to 5 comprises two first frame struts 1.1, 1.2 as well as two second frame struts 2.1, 2.2. The frame shown in perspective in its assembled position in FIGS. 1 to 5 spans a frame plane.

The first frame struts 1.1, 1.2 in each case consist of a first profile strip 3 and the second frame struts 2.1, 2.2 in each case consist of a second profile strip 4, wherein the profile strips 3, 4 in each case have a predetermined length.

The first frame strut 1.1 is connected to the second frame strut 2.1 via a first profile connector 6.1 with axes of rotation 10 oriented parallel to the frame plane, wherein a first connecting arm 7 of the profile connector 6.1 is inserted into the first profile strip 3 of the first frame strut 1.1, and a second connecting arm 8 of the first profile connector 6.1 is inserted into the second profile strip 4 of the second frame strut 2.1. A second profile connector 6.2 with a joint 11 having two axes of rotation 10 oriented parallel to the frame plane connects the second frame strut 2.2 to the first frame strut 1.2.

A first profile connector 5.1 with a rotary joint 11, having two axes of rotation 9 arranged at right angles to the frame plane, connects the first vertical frame strut 1.1 to the second frame strut 2.2 by means of its first connecting arm 7 and its second connecting arm 8. A second profile connector 5.2 with a rotary joint 11, which also has two axes of rotation 9 arranged at right angles to the frame plane, additionally connects the second frame strut 2.1 to the first frame strut 1.2.

A profile connector with axes of rotation 9 arranged at right angles to the frame plane, as is used as the first profile connector 5.1 and second profile connector 5.2, is shown in FIGS. 6 and 7 in detail. The profile connector comprises a first connecting arm 7 and a second connecting arm 8. The connecting arms 7 and 8 in each case have an insertion portion 18 which is inserted into a profile strip of the frame strut. The connecting arms 7 and 8 additionally have in each case a corner portion 19 which protrudes over the profile strips. In each case an axis of rotation 9 is configured on the corner portions 19, said axes of rotation being oriented at right angles to the frame plane and connected together via a connecting element 20.

Additionally a hook-shaped latching element 12 and a stabilising element 14 are also configured on the first connecting arm 7 of the profile connector shown in FIG. 6, whilst a complementary latching element 13 in the form of an undercut and a complementary stabilising element 15 in the form of a recess are configured on the second connecting arm 8.

In the initial position shown in FIG. 6, the insertion portions 18 of the first connecting arm 7 and the second connecting arm 8 are oriented parallel to one another. The profile connector may be transferred by pivoting the first connecting arm 7 and the second connecting arm 8 about the joint 11, which is configured with the two right-angled axes of rotation 9, into the position shown in FIG. 7 in which the insertion portions 18 and thus the connecting arms 7 and 8 are arranged at a right angle to one another. In this position the hook-shaped latching element 12 engages in the complementary latching element 13 formed by an undercut, whilst the stabilising element 14 of the first connecting arm 7, which is configured as a projection, engages in the complementary stabilising element 15 which is configured as the recess. Thus the profile connector is firstly secured against being inadvertently pivoted back by means of the latching element 12 and the complementary latching element 13, and secondly is oriented in a stable manner by means of the stabilising element 14 and the complementary stabilising element 15.

The profile connector shown in FIGS. 8 to 10 also has a first connecting arm 7 and a second connecting arm 8 with in each case an insertion portion 18 and a corner portion 19. The first connecting arm 7 and the second connecting arm 8 are connected together via a rotary joint 11, wherein an axis of rotation 10 oriented parallel to the frame plane is configured in the first connecting arm 7 and a second axis of rotation 10 oriented parallel to the frame plane is configured in the second connecting arm 8. The axes of rotation 10 are connected together via a connecting element 20. Additionally a stabilising element 14 with a hook-shaped latching element 12 configured thereon is configured on the first connecting arm 7, whilst a complementary stabilising element in the form of a recess and a complementary latching element 13 in the form of an undercut are configured on the second connecting arm 8.

In the initial position shown in FIG. 8 the insertion portions 18 of the connecting arms 7 and 8 are oriented parallel to one another. The connecting arms 7 and 8, by pivoting about the two axes of rotation 10 (see FIG. 9), may be brought into the position shown in FIG. 10 in which the insertion portions 18 and thus also the connecting arms 7 and 8 are arranged at a right angle to one another. In the position shown in FIG. 10 the hook-shaped latching element 12 engages behind the undercut as a complementary latching element 13 so that this profile connector is also secured against being inadvertently pivoted back. Additionally the stabilising element 14 of the first connecting arm 7 overlaps the complementary stabilising element 15 of the second connecting arm 8 so that in the position shown in FIG. 10 a high degree of stability is provided.

From FIGS. 6 to 10 it may also be seen that the respective first connecting arm 7 has a receiver 16 into which a suspension element (not shown) may be inserted, wherein due to the resilient configurations of a latching hook the suspension element may be secured in various insertion positions in a simple manner to the profile connector so that a simple adaptation is possible of the suspension element to the depth of a window frame to which the frame is designed to be fastened.

It is thus possible to arrange the frame struts 1.1, 1.2, 2.1 and 2.2 parallel to one another in the initial position shown in FIG. 2, whilst each profile connector 5.1, 5.2, 6.1 and 6.2 is already inserted with its two connecting arms 7, 8 in each case into a profile strip of two frame struts. The frame may thus be delivered preassembled in a very compact state.

In order subsequently to unfold the frame from the initial position into an assembled position, initially the first frame strut 1.1 and the second frame strut 2.1 are pivoted together with the first frame strut 1.2 and the second frame strut 2.2 about the axes of rotation 9 of the profile connectors 5.1 and 5.2 oriented at right angles to the frame plane into the intermediate position shown in FIG. 3. In the intermediate position shown in FIG. 3, the pair of frame struts, consisting of the first frame strut 1.1 and the second frame strut 2.1, are arranged at a right angle to the pair of frame struts, consisting of the first frame strut 1.2 and the second frame strut 2.2, wherein the profile connectors 5.1 and 5.2 are in the state shown in FIG. 7.

Hereinafter (see FIG. 4) the first frame strut 1.2 together with the second frame strut 2.1 are then pivoted relative to the first frame strut 1.1 and the second frame strut 2.2 about the axes of rotation 10 of the profile connectors 6.1 and 6.2 arranged parallel to the frame plane, until all of the frame struts 1.1, 1.2, 2.1 and 2.2 are arranged in one plane in which the first frame struts 1.1 and 1.2 are arranged parallel to one another and at a right angle to the second frame struts 2.1 and 2.2. This position which is also denoted as the assembled position is shown in FIG. 5.

By means of the present invention it is possible to provide the end user with a preassembled frame in a compact manner, wherein the end user subsequently only has to unfold the frame.

### LIST OF REFERENCE NUMERALS

1.1, 1.2 First frame strut
2.1, 2.2 Second frame strut
3 First profile strip
4 Second profile strip
5.1, 5.2 Profile connector with right-angled axis of rotation
6.1, 6.2 Profile connector with parallel axis of rotation
7 First connecting arm
8 Second connecting arm
9 Right-angled axis of rotation
10 Parallel axis of rotation
11 Rotary joint
12 Latching element
13 Complementary latching element
14 Stabilising element
15 Complementary stabilising element
16 Receiver
17.1, 17.2 Receiving groove
18 Insertion portion
19 Corner portion
20 Connecting element

1. An insect protection device with a frame, comprising
at least two first frame struts (1.1, 1.2) and
at least two second frame struts (2.1, 2.2), wherein
the two first frame struts (1.1, 1.2) and/or the two second frame struts (2.1, 2.2) are of invariable length,
the first frame struts (1.1, 1.2) are each connected at their ends to a second frame strut (2.1, 2.2) and the second frame struts (2.1, 2.2) are each connected at their ends to a first frame strut (1.1, 1.2) and
the first frame struts (1.1, 1.2) and the second frame struts (2.1, 2.2) are arranged at a right angle with respect to one another in a frame plane in an assembled position,
and with an insect protection net which is fastened in or on the frame, characterised in that
the connections in each case between a first frame strut (1.1, 1.2) and a second frame strut (2.1, 2.2) each have a rotary joint (11) having at least one axis of rotation (9, 10), wherein
the rotary joints (11) are configured such that
in an initial position the two first frame struts (1.1, 1.2) and the two second frame struts (2.1, 2.2) are oriented parallel to one another, and
the frame is transferrable into the assembled position by pivoting the frame struts (1.1, 1.2, 2.1, 2.2) relative to one another about the axes of rotation (9, 10) of the rotary joints (11).

2. A pavilion structure, having a frame, comprising
at least two first frame struts (1.1, 1.2) and
at least two second frame struts (2.1, 2.2), wherein
the two first frame struts (1.1, 1.2) and/or the two second frame struts (2.1, 2.2) are of invariable length,
the first frame struts (1.1, 1.2) are each connected at their ends to a second frame strut (2.1, 2.2) and the second frame struts (2.1, 2.2) are each connected at their ends to a first frame strut (1.1, 1.2) and
the first frame struts (1.1, 1.2) and the second frame struts (2.1, 2.2) are arranged at a right angle with respect to one another in a frame plane in an assembled position,
characterised in that
the connections in each case between a first frame strut (1.1, 1.2) and a second frame strut (2.1, 2.2) each have a rotary joint (11) having at least one axis of rotation (9, 10), wherein
the rotary joints (11) are configured such that
in an initial position the two first frame struts (1.1, 1.2) and the two second frame struts (2.1, 2.2) are oriented parallel to one another and
the frame is transferrable into the assembled position by pivoting the frame struts (1.1, 1.2, 2.1, 2.2) relative to one another about the axes of rotation (9, 10) of the rotary joints (11).

3. The insect protection device according to claim 1, wherein the axes of rotation (9) of the rotary joints (11) of the corners of the frame diagonally opposing one another in the assembled position are oriented at right angles to the frame plane.

4. The insect protection device according to claim 1, wherein the axes of rotation (10) of the rotary joints (11) of the corners of the frame diagonally opposing one another in the assembled position are oriented parallel to the frame plane or are arranged in the frame plane.

5. The insect protection device according to claim 3, wherein in each case two pairs (1.1 and 2.1, 1.2 and 2.2) of parallel frame struts are initially transferrable from the initial position by pivoting about the axes of rotation (9) oriented at right angles to the frame plane into an intermediate position in which the two pairs (1.1 and 2.1, 1.2 and 2.2) of parallel frame struts are arranged at a right angle to one another, wherein the frame struts are subsequently transferrable from the intermediate position into the assembled position by pivoting two pairs (1.1 and 2.2, 1.2 and 2.1) of frame struts, which are arranged at right angles to one another in the intermediate position, about axes of rotation (10) arranged parallel to or in the frame plane.

6. The insect protection device according to claim 1, wherein an axis of rotation (9, 10) for the respective rotary joint (11) is configured at each end of a frame strut.

7. The insect protection device according to claim 1, wherein the two first frame struts (1.1, 1.2) or the two second frame struts (2.1, 2.2) comprise at least one outer profile strip and at least one inner profile strip which is inserted in a telescopic manner to an insertion depth into the outer profile strip(s).

8. The insect protection device according to claim 1, wherein a separate fixing element (23) is provided for each rotary joint (11), said fixing element being able to be connected to two adjacent frame struts in the region of the rotary joints (11) in the assembled position and thus securing the adjacent frame struts against being pivoted.

9. The insect protection device according to claim 1, wherein
the frame struts each have a profile strip (3, 4) and
profile connectors (5.1, 5.2, 6.1, 6.2) which each have at least one first connecting arm (7) and one second connecting arm (8) are provided, wherein
the first connecting arm (7) is connected by means of a plug-in connection to a first profile strip (3) and the second connecting arm (8) is connected by means of a plug-in connection to an adjacent second profile strip (4), wherein
the rotary joint (11) is configured between the first connecting arm (7) and the second connecting arm (8).

10. The insect protection device according to claim 9, wherein the first connecting arm (7) of a profile connector (5.1, 5.2, 6.1, 6.2) has a projecting stabilising element (14) which
in the assembled position overlaps the second connecting arm (8) of the profile connector (5.1, 5.2, 6.1, 6.2).

11. The insect protection device according to claim 9, wherein
the first connecting arm (7) has a first receiving channel (21) and the second connecting arm (8) has a second receiving channel (22), wherein in the assembled position the first receiving channel (21) and the second receiving channel (22) are arranged aligned with one another, and
a separate fixing element (23) is provided, wherein the fixing element (23) in the assembled position is able to be introduced into the first receiving channel (21) and into the second receiving channel (22), so that the first connecting arm (7) and the second connecting arm (8) are secured against a relative movement.

12. The pavilion structure according to claim 2, wherein third frame struts for forming a roof structure and fourth frame struts for forming feet are attached in an articulated manner at the ends of the first and second frame struts.

13. The pavilion structure according to claim 2, wherein the axes of rotation (9) of the rotary joints (11) of the corners of the frame diagonally opposing one another in the assembled position are oriented at right angles to the frame plane.

14. The pavilion structure according to claim 2, wherein the axes of rotation (10) of the rotary joints (11) of the corners of the frame diagonally opposing one another in the assembled position are oriented parallel to the frame plane or are arranged in the frame plane.

15. The pavilion structure according to claim 13, wherein in each case two pairs (1.1 and 2.1, 1.2 and 2.2) of parallel frame struts are initially transferrable from the initial position by pivoting about the axes of rotation (9) oriented at right angles to the frame plane into an intermediate position in which the two pairs (1.1 and 2.1, 1.2 and 2.2) of parallel frame struts are arranged at a right angle to one another, wherein the frame struts are subsequently transferrable from the intermediate position into the assembled position by pivoting two pairs (1.1 and 2.2, 1.2 and 2.1) of frame struts, which are arranged at right angles to one another in the intermediate position, about axes of rotation (10) arranged parallel to or in the frame plane.

16. The pavilion structure according to claim 2, wherein an axis of rotation (9, 10) for the respective rotary joint (11) is configured at each end of a frame strut.

17. The pavilion structure according to claim 2, wherein the two first frame struts (1.1, 1.2) or the two second frame struts (2.1, 2.2) comprise at least one outer profile strip and at least one inner profile strip which is inserted in a telescopic manner to an insertion depth into the outer profile strip(s).

18. The pavilion structure according to claim 2, wherein a separate fixing element (23) is provided for each rotary joint (11), said fixing element being able to be connected to two adjacent frame struts in the region of the rotary joints (11) in the assembled position and thus securing the adjacent frame struts against being pivoted.

19. The pavilion structure according to claim 2, wherein
the frame struts each have a profile strip (3, 4) and
profile connectors (5.1, 5.2, 6.1, 6.2) which each have at least one first connecting arm (7) and one second connecting arm (8) are provided, wherein
the first connecting arm (7) is connected by means of a plug-in connection to a first profile strip (3) and the second connecting arm (8) is connected by means of a plug-in connection to an adjacent second profile strip (4), wherein
the rotary joint (11) is configured between the first connecting arm (7) and the second connecting arm (8).

20. The pavilion structure according to claim 19, wherein the first connecting arm (7) of a profile connector (5.1, 5.2, 6.1, 6.2) has a projecting stabilising element (14) which in the assembled position overlaps the second connecting arm (8) of the profile connector (5.1, 5.2, 6.1, 6.2).
